(19) United States
(12) Patent Application Publication
(10) Pub. No.: US 2021/0201284 A1
(43) Pub. Date: Jul. 1, 2021

(54) SALE SYSTEM AND CONTROLLING METHOD THEREOF

(71) Applicant: INDUSTRIAL TECHNOLOGY RESEARCH INSTITUTE, Hsinchu (TW)

(72) Inventors: Yu-Hsiang TSAI, Zhubei City (TW); Kuan-Ting CHEN, Douliu City (TW); Heng-Yin CHEN, Zhubei City (TW); Chin-Ming HAO, Taoyuan City (TW); Chun-Yen HUANG, Changhua City (TW)

(73) Assignee: INDUSTRIAL TECHNOLOGY RESEARCH INSTITUTE, Hsinchu (TW)

(21) Appl. No.: 16/854,481

(22) Filed: Apr. 21, 2020

(30) Foreign Application Priority Data
Dec. 31, 2019 (TW) 108148499

(51) Int. Cl. G06Q 20/20; G06Q 20/26; G07C 9/00; G07C 9/37

(52) U.S. Cl. CPC G06Q 20/202; G06Q 20/206; G07C 9/37; G06Q 20/26; G07C 9/00912; G06Q 20/203

(57) ABSTRACT

A sale system and a controlling method thereof are provided. The sale system includes a data acquisition unit, a door, a door control unit, a first image capturing unit, a determining unit and a payment unit. The data acquisition unit is configured to obtain a consumer payment information and withdrawal rights. The door control unit is configured to unlock the door when the consumer payment information and withdrawal rights is obtained. The first image capturing unit is configured to capture an image of a product. When the door is closed, the determining unit determines whether the product has been taken according to the image or a sensing information. When the product has been taken, the payment unit charges a payment based on the consumer payment information and withdrawal rights.

This application claims the benefit of Taiwan application Serial No. 108148499, filed Dec. 31, 2019, the disclosure of which is incorporated by reference herein in its entirety.

### TECHNICAL FIELD

The disclosure relates in general to a sale system and a controlling method thereof.

### BACKGROUND

With the development of technology, the sale model of goods is constantly changing. The importance of online shopping experience is realized for the traditional in-store shopping (offline shopping). Therefore, how to develop a kind of smart sale system that provides online shopping experience for the in-store shopping (offline shopping) to make online shopping/offline shopping drive each other's operations has become one of the current development directions.

Under the goal of smart sale system, what is needed is the ability to provide interactive product information, sell on shelves, price comparison and other functions at the offline shopping.

In addition, in the era of full access, transactions, shipping, and pick-up locations are no longer limited. How to allow customers and sellers to share resources to promote the development of a circular economy is also an important goal.

### SUMMARY

The disclosure is related to a sale system and a controlling method thereof.

According to one embodiment, a controlling method of a sale system is provided. The controlling method includes the following steps. A consumer payment information and withdrawal rights is obtained. A door is unlocked. An image of a product is captured by a first image capturing unit. Whether the product has been taken according to the image or a sensing information is determined, when the door is closed. A payment is charged based on the consumer payment information and withdrawal rights, when the product has been taken.

According to another embodiment, a sale system is provided. The sale system includes a data acquisition unit, a door, a door control unit, a first image capturing unit, a determining unit and a payment unit. The data acquisition unit is configured to obtain a consumer payment information and withdrawal rights. The door control unit is configured to unlock the door when the consumer payment information and withdrawal rights is obtained. The first image capturing unit is configured to capture an image of a product. The determining unit is configured to determine whether the product has been taken according to the image or a sensing information, when the door is closed. The payment unit is configured to charge a payment based on the consumer payment information and withdrawal rights, when the product has been taken.

According to an embodiment, a sale system is provided. The sale system includes a data acquisition unit, a door, a door control unit, a first image capturing unit, a determining unit and an archiving unit. The data acquisition unit is configured to obtain a seller payment information and withdrawal rights. The door control unit is configured to unlock the door when the seller payment information and withdrawal rights is obtained. The first image capturing unit is configured to capture an image of a product. The determining unit is configured to determine whether the product has been placed according to the image or a sensing information, when the door is closed. The archiving unit is configured to create a sales data according to the seller payment information and withdrawal rights, when the product has been placed.

### BRIEF DESCRIPTION OF THE DRAWINGS

FIG. 1 shows a block diagram of a sale system according to one embodiment.

FIG. 2 shows an example of the sale system.

FIG. 3A shows a flowchart of the controlling method of the sale system which are used by the customer.

FIG. 3B shows a flowchart of the controlling method of the sale system which is used by the seller.

FIG. 4 shows a user standing in front of the box.

FIG. 5 shows that the door is opened.

FIG. 6 shows that the door is closed.

FIG. 7 shows a seller standing in front of the box.

FIG. 8 shows that the door is opened.

FIG. 9 shows that the door is closed.

FIG. 10 shows a sale system including a sample box and a product box.

FIG. 11A shows the flowchart of the controlling method of the sample box when the customer operates the sample box.

FIG. 11B shows the flowchart of the controlling method of the product box when the customer operates the product box.

FIG. 11C shows the flowchart of the controlling method of the sample box when the seller operates the sample box.

FIG. 11D shows the flowchart of the product box when the seller operates the product box.

FIG. 12 shows that the door of the product box has been opened.

FIG. 13 shows that the door of the product box is closed.

FIG. 14 illustrates an example that the customer operates the sale system.

FIG. 15 illustrates another example that the customer operates the sale system.

FIG. 16 illustrates another example that the customer operates the sale system.

In the following detailed description, for purposes of explanation, numerous details are set forth in order to provide a thorough understanding of the disclosed embodiments. It will be apparent, however, that one or more embodiments may be practiced without these details. In other instances, well-known structures and devices are schematically shown in order to simplify the drawing.

### DETAILED DESCRIPTION

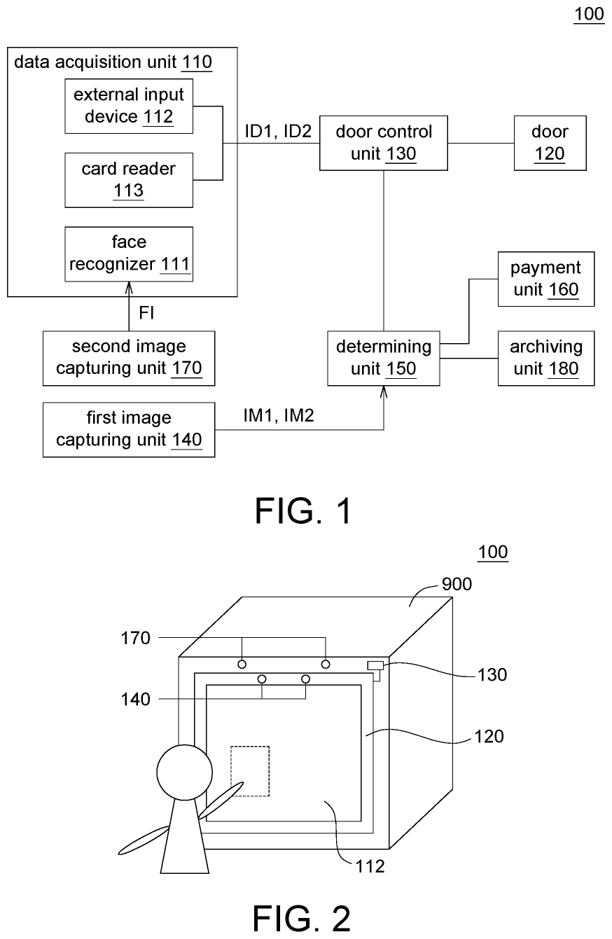

Please refer to FIGS. 1 and 2. FIG. 1 shows a block diagram of a sale system 100 according to one embodiment. FIG. 2 shows an example of the sale system 100. The sale system 100 includes a data acquisition unit 110, a door 120, a door control unit 130, a first image capturing unit 140, a determining unit 150, a payment unit 160, a second image capturing unit 170 and an archiving unit 180.

The data acquisition unit 110 is configured to obtain a consumer payment information and withdrawal rights ID1 or a seller payment information and withdrawal rights ID2. For example, the consumer payment information and withdrawal rights ID1 or the seller payment information and withdrawal rights ID2 is obtained by a face recognizer 111, an external input device 112, (such as light transmittable touch display panel, keyboard, voice recognition device), or a card reader 113. The data acquisition unit 110 is, for example, at least one of the face recognizer 111, the external input device 112 and the card reader 113, or a combination thereof.

The door 120 may be a light transmittable display, light transmittable glass door or light transmittable acrylic door. The door 120 is disposed at the box 900, such as a product box or a sample box. The door 120 can be closed or opened. The door control unit 130 is configured to unlock or lock the door 120. The door control unit 130 is, for example, a chip, a circuit board, a circuit, a plurality of program codes or a storage device storing the program codes. The archiving unit 180 is configured to archive data. The archiving unit 180 is, for example, a chip, a circuit board, a circuit, a plurality of program codes or a storage device storing the program codes.

In the sale system 100, the seller can place the product in the box 900 for sale, and the customer can perform interactive operation (such as product trial, specification inquiry or customer service inquiry, service language change, product recommendation, usage guidance, information delivery and other services) at the box 900. The operation of the above mentioned elements is illustrated via a flowchart.

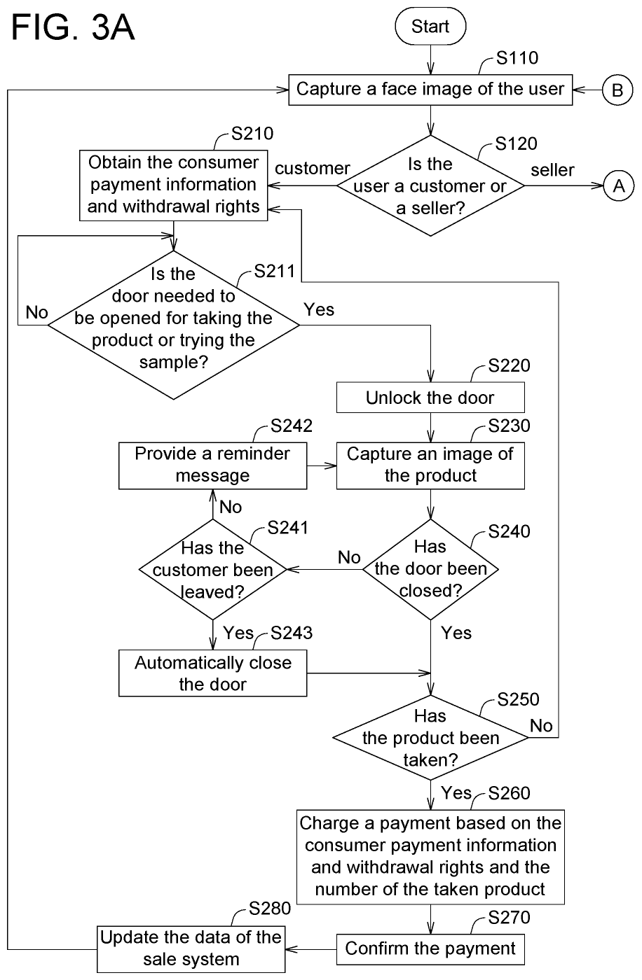

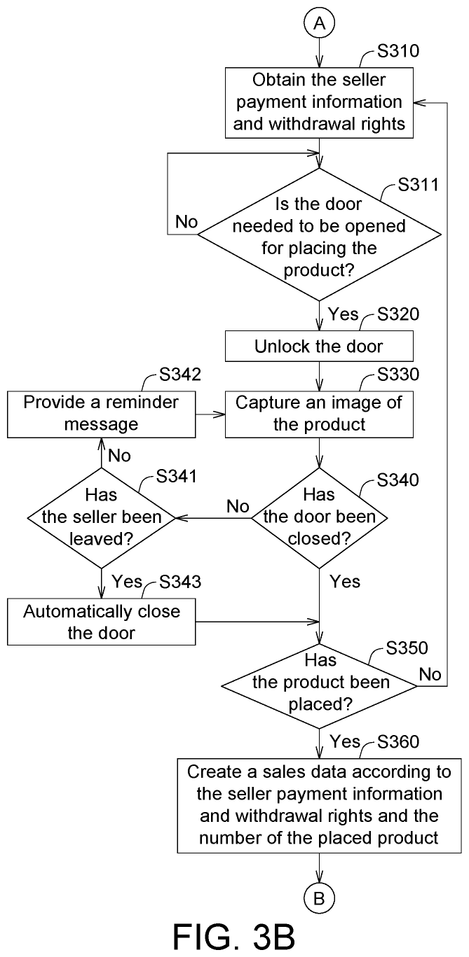

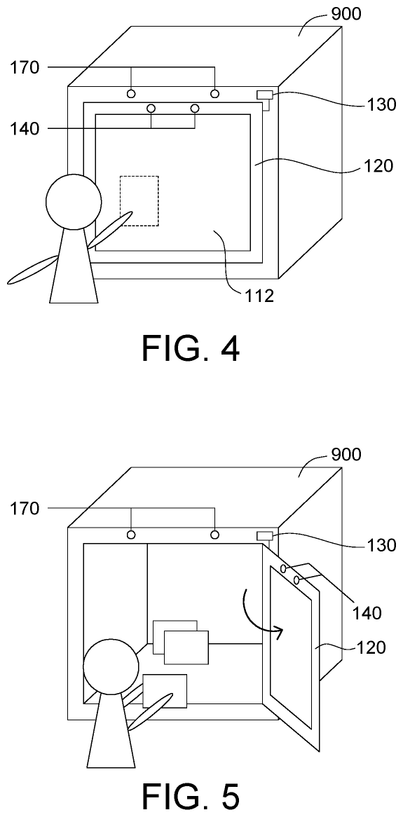

Please refer to FIGS. 3A, 3B and 4. FIG. 3A shows a flowchart of the controlling method of the sale system 100 which are used by the customer. FIG. 3B shows a flowchart of the controlling method of the sale system 100 which is used by the seller. FIG. 4 shows a user standing in front of the box 900. Firstly, in the step S110, the second image capturing unit 170 captures a face image FI of the user.

Next, in the step S120, the face recognizer 111 identifies whether the user is a customer or a seller according to the face image FI. In this step, a database records facial features of at least one seller. The face recognizer 111 performs a matching procedure to determine whether the face image FI is similar to the face of one of the sellers. If the face image FI is similar to the face of one of the seller, then the user is identified as a seller and the process proceeds to the step S310 of FIG. 3B. If the face image FI is not similar to the face of any one of the sellers, then the user is identified as a customer and the process proceeds to the step S210.

In the step S210, the external input device 112 or the card reader 113 of the data acquisition unit 110 obtains the consumer payment information and withdrawal rights ID1. For example, the step S210 may include the following steps. As shown in FIG. 4, the external input device 112 provides at least one inputting field. Then, the consumer payment information and withdrawal rights ID1 is received via the inputting field. The external input device 112 may be disposed on the door 120. The door 120 and the external input device 112 may be light transmittable, such that the user can see the product while operating the external input device 112. In one embodiment, the external input device 112 may display some information corresponding to each part of the product for illustrating the function of each part.

Or, in case of the customer being a specific ethnic group (such as students in a dormitory, employees in an office building, tenants in a hotel, members of a shop), the step S210 includes the following steps. The second image capturing unit 170 captures the face image FI of the user. Then, the consumer payment information and withdrawal rights ID1 is obtained from a database according to the face image FI.

Or, in one embodiment, the step S210 may include the following steps. The card reader 113 reads one card (such as student ID card, work ID card, room card, membership ID card). The consumer payment information and withdrawal rights ID1 is obtained according to this card.

Afterwards, refer to FIGS. 3A and 5. FIG. 5 shows that the door 120 is opened. In the step S211, whether the door 120 is needed to be opened for taking the product or trying the sample is determined. If the door 120 is needed to be opened for taking the product or trying the sample, the process proceeds to the step S220. In the step S220, the door control unit 130 unlocks the door 120. The door 120 can be opened to the right or the left, and it is not limited thereto. The door 120 can be opened automatically when the door 120 is unlocked. Or, the door 120 can be opened manually when the door 120 is unlocked. How to open the door 120 can be designed according to the actual need. As shown in FIG. 5, the first image capturing unit 140 may be disposed on the door 120. In the step S220 of unlocking the door 120 to open the door 120, the first image capturing unit 140 is rotated with the door 120.

In the step S230, the first image capturing unit 140 captures an image IM1 of the product. The image IM1 may be a dynamic video or a static image. Before the door 120 is opened, the first image capturing unit 140 faces the internal of the box 900. After the door 120 is opened, the first image capturing unit 140 faces the external of the box 900. Therefore, the sale system 100 may monitor whether the consumer has taken the product.

Next, after a predetermined time, the step S240 is performed. In the step S240, the determining unit 150 (shown in FIG. 1) determines whether the door 120 of the product box 920 has been closed. If the door 120 of the product box 920 has been closed, then the process proceeds to step S250; if the door 120 of the product box 920 has not been closed, then the process proceeds to step S241.

In the step S241, the determining unit 150 determines whether the customer has been leaved. If the customer has not has been leaved, then the process proceeds to the step S242; if the customer has been leaved, then the process proceeds to step S243.

In the step S242, a reminder message, such as “the door is opened too long”, can be provided.

In step S243, the door control unit 130 automatically closes the door 120.

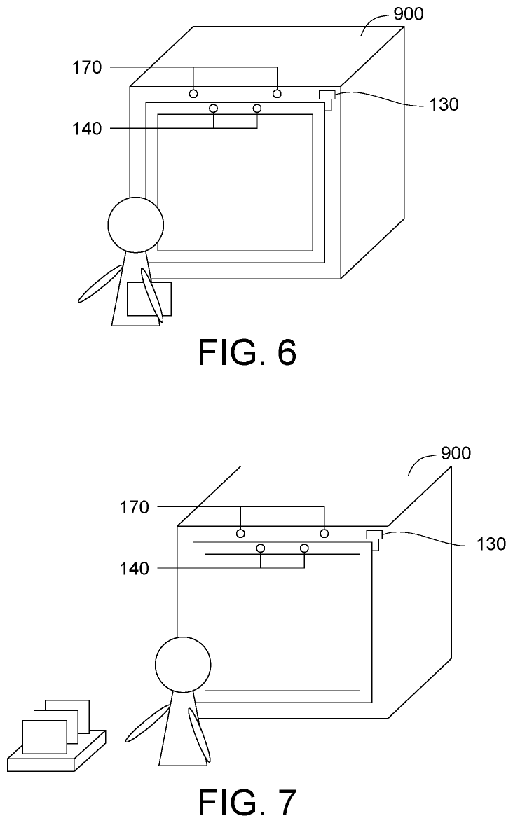

Please refer to FIGS. 3A and 6. FIG. 6 shows that the door 120 is closed. In the step S250, the door 120 has been closed, and the determining unit 150 determines whether the product has been taken. If the product has been taken, then the process proceeds to step S260; if the product has not been taken, then the process proceeds to step S210. The image IM1 may be a dynamic video or multiple static pictures captured from a time when the door 120 is closed to a time when the door 120 is closed. The determining unit 150 may watch the product in the image IM1 to determine whether the product is moved away from the box 900. Or, the determining unit 150 may watch the product and the customer in the image IM1 to determine whether the product is moved with the customer and moved away from the box 900.

In one embodiment, the determining unit 150 may determine whether a radio frequency identification (RFID) of the product is out of a sensing range to double confirm whether the product has been removed.

Or, the determining unit 150 may determine whether a weight of a pallet carrying the product is changed to double confirm whether the product has been removed.

Or, the determining unit 150 may determine whether a magnetic button attached to the product is separated to double confirm whether the product has been removed.

In the step S260, the product has been taken and the payment unit 160 charges a payment based on the consumer payment information and withdrawal rights ID1 and the number of the taken product.

In the step S270, the payment unit 160 confirms the payment. For example, the payment unit 160 shows a confirm message on the external input device 112 (such as a light transmittable touch display panel or a mobile device). Once a reply message is received, the payment is decided.

In the step S280, the archiving unit 180 updates the data of the sale system 100.

Base on above steps, the sale system 100 provides a self-service store. The customer can perform product trial and take the product by himself. After the customer signs in the sale system 100 with the consumer payment information and withdrawal rights ID1, the door 120 will be unlocked. Then, the customer can take the product by himself. The first image capturing unit 140 assists in determining whether the product has been taken, and then the payment is charged.

In addition to the customer, the seller can use the sale system 100 also. Referring to FIG. 7, which shows a seller standing in front of the box 900. In the step S120 of FIG. 3A, if the face image FI is similar to the face of one of the sellers, then this user is deemed as a seller, and the process proceeds to the step S310 of FIG. 3B.

As shown in FIG. 3B, in the step S310, the external input device 112 or the card reader 113 of the data acquisition unit 110 obtains the seller payment information and withdrawal rights ID2. For example, the step S310 may include the following steps. As shown in FIG. 7, the external input device 112 provides at least one inputting field. Then, the seller payment information and withdrawal rights ID2 is received via the inputting field. The external input device 112 may be disposed on the door 120. The door 120 and the external input device 112 may be light transmittable, such that the seller can know whether the box 900 is empty while operating the external input device 112.

Or, in one embodiment, the data of the sellers may be recorded in a database. The step S310 may include the following steps. The second image capturing unit 170 captures the face image FI of the user. Then, the seller payment information and withdrawal rights ID2 is obtained through the database according to the face image FI.

Or, in one embodiment, the step S310 may include the following steps. The card reader 113 reads one card (such as membership ID card). The seller payment information and withdrawal rights ID2 is obtained according to this card.

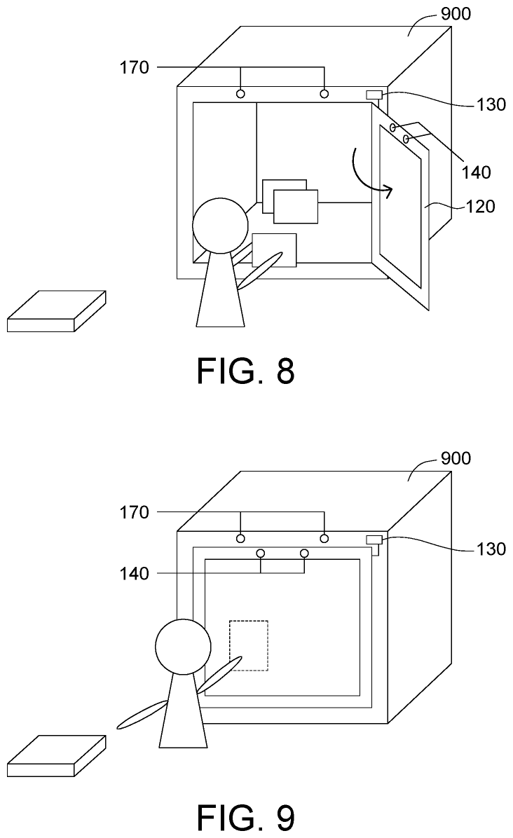

Afterwards, refer to FIGS. 3B and 8. FIG. 8 shows that the door 120 is opened. In the step S311, whether the door 120 is needed to be opened for placing the product is determined. If the door 120 is needed to be opened, then the process proceeds to the step S320. In the step S320, the door control unit 130 unlocks the door 120. The door 120 can be opened automatically when the door 120 is unlocked. Or, the door 120 can be opened manually when the door 120 is unlocked. As shown in FIG. 8, the first image capturing unit 140 may be disposed on the door 120. In the step S320 of unlocking the door 120, the first image capturing unit 140 is rotated with the door 120.

In the step S330, the first image capturing unit 140 captures the image IM1 of the product. The image IM1 may be a dynamic video or a static image. Before the door 120 is opened, the first image capturing unit 140 faces the internal of the box 900. After the door 120 is opened, the first image capturing unit 140 faces the external of the box 900. Therefore, the sale system 100 may monitor whether the seller has placed the product.

Next, after a predetermined time, the step S340 is performed. In the step S340, the determining unit 150 determines whether the door 120 has been closed. If the door 120 has been closed, then the process proceeds to the step S350; if the door 120 has not been closed, then the process proceeds to the step S341.

In the step S341, the determining unit 150 determines whether the seller has been leaved. If the seller has not been leaved, then the process proceeds to the step S342; if the seller has been leaved, then the process proceeds to the step S343.

In the step S342, a reminder message, such as “the door is opened too long”, can be provided.

In the step S343, the door control unit 130 automatically closes the door 120.

Please refer to FIGS. 3B and 9. FIG. 9 shows that the door 120 is closed. In the step S350, the door 120 has been closed, the determining unit 150 (shown in FIG. 1) determines whether the product has been placed. If the product has been placed, then the process proceeds to the step S360; if the has not been placed, then the process proceeds to the step S310. The image IM1 may be a dynamic video or multiple static pictures captured from a time when the door 120 is closed to a time when the door 120 is closed. In FIG. 9, the determining unit 150 may watch the product in the image IM1 to determine whether the product is moved into the box 900. Or, the determining unit 150 may watch the product the seller in the image IM1 to determine whether the product is moved with the seller and moved into the box 900.

In one embodiment, the determining unit 150 may determine whether a radio frequency identification (RFID) of the product enters sensing range to double confirm whether the product has been placed.

Or, the determining unit 150 may determine a weight of a pallet carrying the product is changed to double confirm whether the product has been placed.

In the step S360, the product has been placed and the archiving unit 180 creates a sales data according to the seller payment information and withdrawal rights ID2 and the number of the placed product. The sales data may be the price, which can be dynamic, product description, 3D or 2D product pattern, product introduction video.

Base above steps, the sale system 100 provides a self-service store. The seller can prepare any product and place the product by himself. After the seller signs in the sale system 100 with the seller payment information and withdrawal rights ID2, the door 120 will be unlocked. Then, the seller can place the product. The first image capturing unit 140 assists in determining whether the product has been placed, and then the sales data is created.

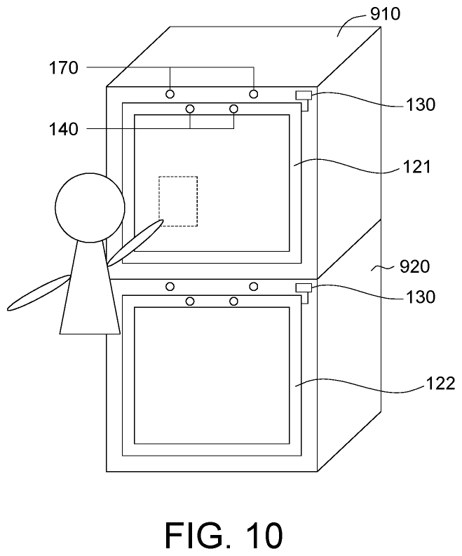

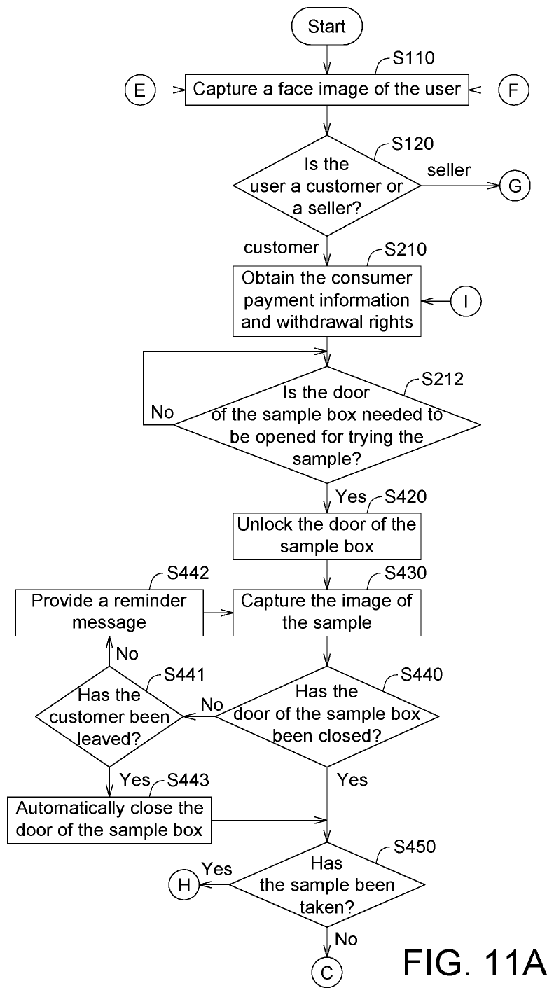

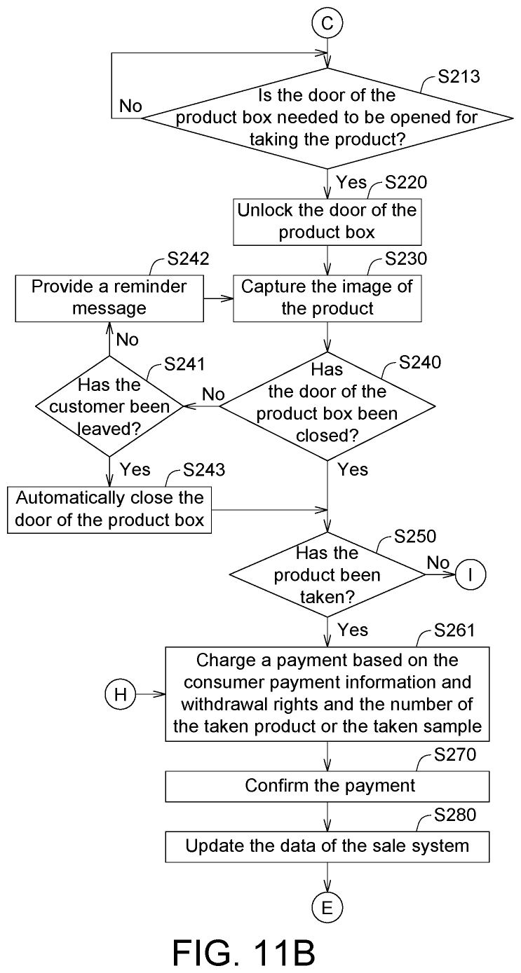

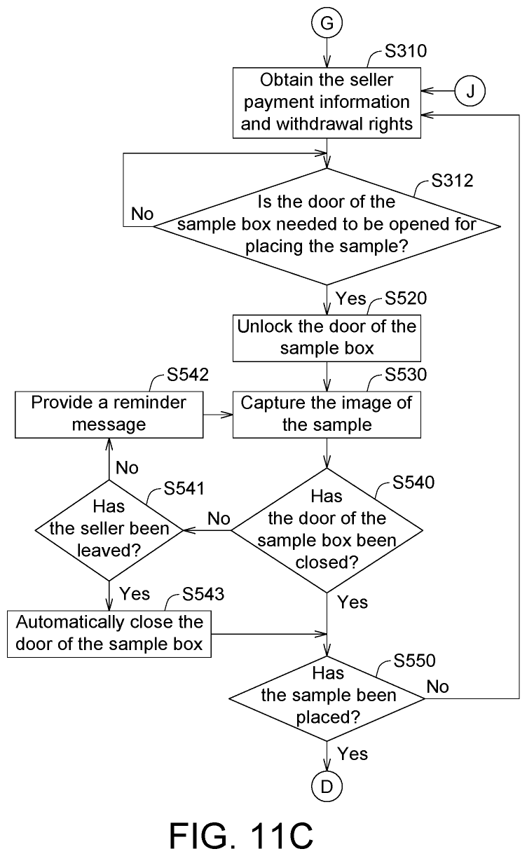

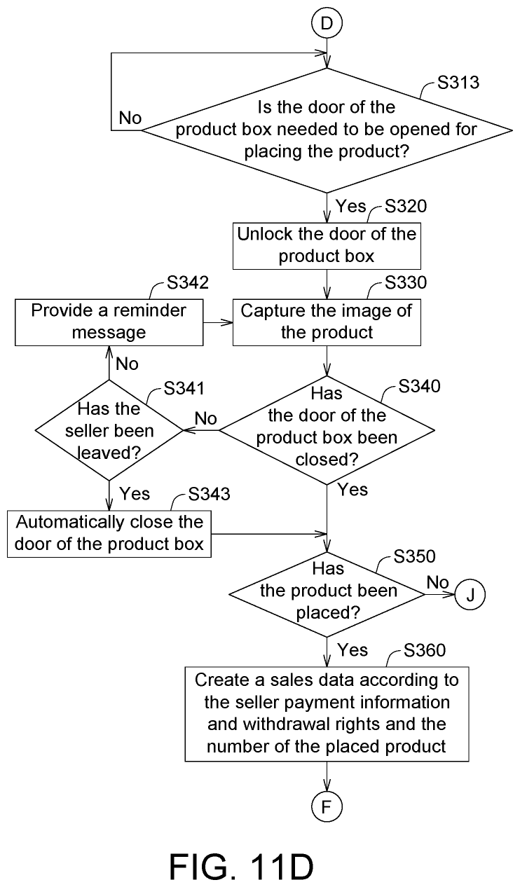

Refer to FIG. 10, which shows a sale system including a sample box 910 and a product box 920. In this embodiment, the sample box 910 is used for placing a sample, and the product box 920 is used for placing the product. Referring to FIGS. 11A to 11D, which shows flowcharts of a controlling method of the sample box 910 and the product box 920. FIG. 11A shows the flowchart of the controlling method of the sample box 910 when the customer operates the sample box 910. FIG. 11B shows the flowchart of the controlling method of the product box 920 when the customer operates the product box 920. FIG. 11C shows the flowchart of the controlling method of the sample box 910 when the seller operates the sample box 910. FIG. 11D shows the flowchart of the product box 920 when the seller operates the product box 920. Refer to FIG. 11A. In the step S110, the second image capturing unit 170 captures the face image FI. Next, in the step S120, the face recognizer 111 identifies whether the user is a customer or a seller according to the face image FI. If the face image FI is similar to the face of one of the seller, then the user is identified as a seller and the process proceeds to the step S310; If the face image FI is not similar to the face of any one of the sellers, then the user is identified as a customer and the process proceeds to the step S210.

In the step S210, the external input device 112 or the card reader 113 of the data acquisition unit 110 obtains the consumer payment information and withdrawal rights ID1.

In the step S212, whether the door 121 of the sample box 910 is needed to be opened for trying the sample is determined. If the door 120 of the product box 920 is needed to be opened for taking the product or trying the sample, the process proceeds to the step S420. In the step S420, the door control unit 130 unlocks the door 121 of the sample box 910.

In the step S430, the first image capturing unit 140 captures an image IM2 of the sample.

Then, after a predetermined time, the step S440 is performed. In the step S440, the determining unit 150 (shown in FIG. 1) determines whether the door 121 of the sample box 910 has been closed. If the door 121 of the sample box 910 has been closed, then the process proceeds to the step S450; if the door 121 of the sample box 910 has not been closed, then the process proceeds to the step S441.

In the step S441, the determining unit 150 determines whether the customer has been leaved. If the customer has not been leaved, then the process proceeds to the step S442; if the customer has been leaved, then the process proceeds to the step S443.

In the step S442, a reminder message, such as “the door is opened too long”, can be provided.

In the step S443, the door control unit 130 automatically closes the door 121 of the sample box 910.

In the step S450, the door 121 has been closed, and the determining unit 150 determines whether the sample has been taken. If the sample has been taken, then the process proceeds to the step S261 of FIG. 11B; if the sample has not been taken, then the process proceeds to the step S213 of FIG. 11B. In the step S213, whether the door 122 of the product box 920 is needed to be opened for taking the product is determined. If the door 122 of the product box 920 is needed to be opened for taking the product, then the process proceeds to the step S220 of FIG. 11B.

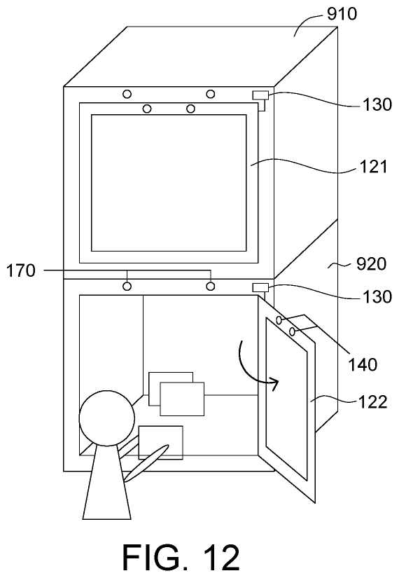

Refer to FIGS. 11B and 12. FIG. 12 shows that the door 122 of the product box 920 has been opened. In the step S220, the door control unit 130 unlocks the door 122 of the product box 920.

In the step S230, the first image capturing unit 140 captures the image IM1 of the product.

Then, after a predetermined time, the step S240 is performed. In the step S240, the determining unit 150 (shown in FIG. 1) determines whether the door 122 of the product box 920 has been closed. If the door 122 of the product box 920 has been closed, then the process proceeds to the step S250; if the door 122 of the product box 920 has not been closed, then the process proceeds to the step S241.

In the step S241, the determining unit 150 determines whether the customer has been leaved. If the customer has not been leaved, then the process proceeds to the step S242; if the customer has been leaved, then the process proceeds to the step S243.

In the step S242, a reminder message, such as “the door is opened too long”, can be provided.

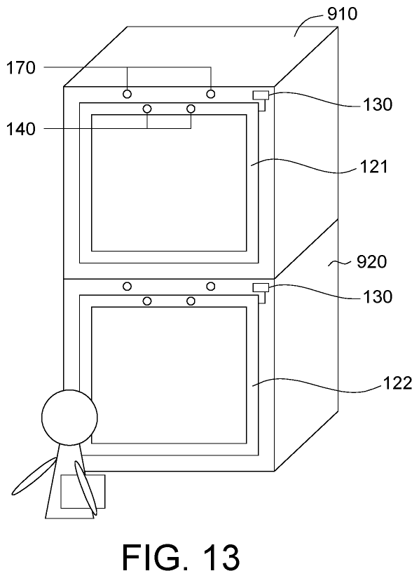

Refer to FIG. 13, which shows that the door 122 of the product box 920 is closed. In the step S243, the door control unit 130 automatically closes the door 122 of the product box 920.

In the step S250, the door 122 has been closed, and the determining unit 150 determines whether the product has been taken. If the product has been taken, then the process proceeds to the step S261; if the product has not been taken, then the process proceeds to the step S210 of FIG. 11A.

In the step S261, the product or the sample has been taken, the payment unit 160 charges a payment based on the consumer payment information and withdrawal rights ID1 and the number of the taken product or the taken sample.

In the step S270, the payment unit 160 confirms the payment.

In the step S280, the archiving unit 180 updates the data of the sale system 100.

Refer to the step S120 of FIG. 11A. If the face recognizer 111 deems this user as the seller according to the face image FI, then the process proceeds to step S310 of FIG. 11C.

As shown in FIG. 11C, in the step S310, the external input device 112 or the card reader 113 of the data acquisition unit 110 obtains the seller payment information and withdrawal rights ID2.

In the step S312, whether the door 121 of the sample box 910 is needed to be opened for placing the sample is determined. If the door 121 of the sample box 910 is needed to be opened for placing the sample, then the process proceeds to the step S520. In the step S520, the door control unit 130 unlocks the door 121 of the sample box 910.

In the step S530, the first image capturing unit 140 captures the image IM2 of the sample.

Then, after a predetermined time, the step S540 is performed. In the step S540, the determining unit 150 determines whether the door 121 of the sample box 910 has been closed. If the door 121 of the sample box 910 has been closed, then the process proceeds to the step S550; if the door 121 of the sample box 910 has not been closed, then the process proceeds to the step S541.

In the step S541, the determining unit 150 determines whether the seller has been leaved. If the seller has not been leaved, then the process proceeds to the step S542; if the seller has been leaved, then the process proceeds to the step S543.

In the step S542, a reminder message, such as “the door is opened too long”, can be provided.

In the step S543, the door control unit 130 automatically closes the door 121 of the sample box 910.

In the step S550, the door 121 has been closed, and the determining unit 150 (shown in FIG. 1) determines whether the sample has been placed. If the sample has been placed, then the process precedes to the step S313 of FIG. 11D. In the step S313 of FIG. 11D, whether the door 122 of the product box 920 is needed to be opened for placing the product is determined. If the door 122 is needed to be opened for placing the product, then the process proceeds to the step S320.

As shown in FIG. 11D, in the step S320, the door control unit 130 unlocks the door 122 of the product box 920.

In the step S330, the first image capturing unit 140 captures an image IM1 of the product.

Then, after a predetermined time, the step S340 is performed. The determining unit 150 determines whether the door 122 has been closed. If the door 122 of the product box 920 has been closed, then the process proceeds to the step S350; if the door 122 of the product box 920 has not been closed, then the process proceeds to step S341.

In the step S341, the determining unit 150 determines whether the seller has been leaved. If the seller has not been leaved, then the process proceeds to the step S342; if the seller has been leaved, then the process proceeds to the step S343.

In the step S342, a reminder message, such as “the door is opened too long”, can be provided.

In the step S343, the door control unit 130 automatically closes the door 122 of the product box 920.

In the step S350, the door 122 has been closed, and the determining unit 150 (shown in FIG. 1) whether the product has been placed. If the product has been placed, then the process proceeds to the step S360; if the product has not been placed, the process proceeds to the step S310 of FIG. 11C.

In the step S360, the product has been placed and the archiving unit 180 creates a sales data according to the seller payment information and withdrawal rights ID2 and the number of the placed product.

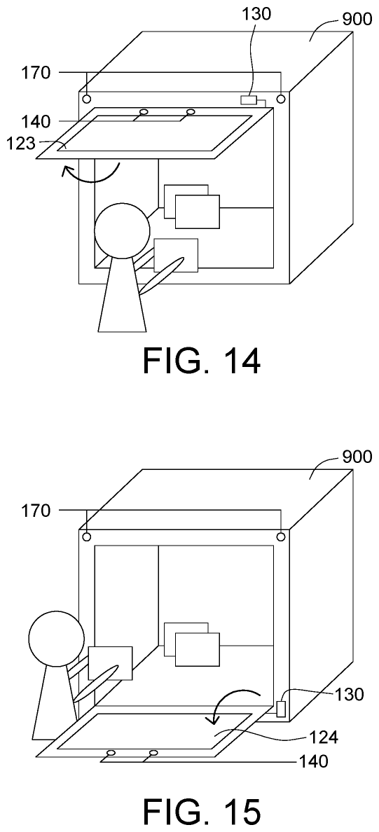

Refer to FIG. 14, which illustrates an example that the customer operates the sale system. In this example, the door 123 is a lift-up structure. Before the door 123 is opened, the first image capturing unit 140 faces the internal of the box 900. After the door 123 is opened, the first image capturing unit 140 faces the external of the box 900.

Refer to FIG. 15, which illustrates another example that the customer operates the sale system. In this example, the door 124 is a lift-down structure. Before the door 124 is opened, the first image capturing unit 140 faces the internal of the box 900. After the door 124 is opened, the first image capturing unit 140 faces the external of the box 900.

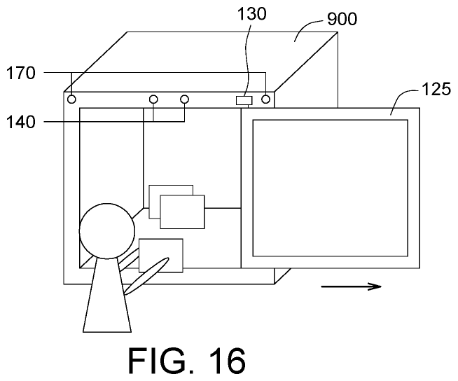

Refer to FIG. 16, which illustrates another example that the customer operates the sale system. In this example, the door 125 is a sliding structure. No matter the door 125 is opened or not, the first image capturing unit 140 faces the internal of the box 900. That is to say, the first image capturing unit 140 continuously faces the product, and the determining unit 150 determines whether the product has been disappeared from the image IM1. If the product has been disappeared from the image IM1, it is deemed that the product has been taken.

In the sale system 100, the seller can place the product in the box 900 for sale, and the customer can perform interactive operation (such as product trial, specification inquiry or customer service inquiry, service language change, product recommendation, usage guidance, information delivery and other services) at the box 900. As such, the customers and the sellers can share resources to promote the development of a circular economy.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A controlling method of a sale system, comprising:
obtaining a consumer payment information and withdrawal rights;
unlocking a door to open the door;
capturing, by a first image capturing unit, an image of a product;
determining whether the product has been taken according to the image or a sensing information, when the door is closed; and
charging a payment based on the consumer payment information and withdrawal rights, when the product has been taken.

2. The controlling method of the sale system according to claim 1, wherein the door is disposed at a sample box or a product box, the product box is used for placing the product, and the sample box is used for placing a sample.

3. The controlling method of the sale system according to claim 1, wherein the step of obtaining the consumer payment information and withdrawal rights includes:
providing at least one inputting field on an external input device, and receiving the consumer payment information and withdrawal rights via the inputting field; or
capturing a face image of a user by a second image capturing unit, and obtaining the consumer payment information and withdrawal rights according to the face image; or
reading a card by a card reader, and obtaining the consumer payment information and withdrawal rights according to the card.

4. The controlling method of the sale system according to claim 3, wherein the external input device is disposed on the door, and the door is light transmittable.

5. The controlling method of the sale system according to claim 1, wherein the first image capturing unit is disposed on the door, in the step of unlocking the door to open the door, the first image capturing unit is rotated with the door.

6. The controlling method of the sale system according to claim 1, the image is captured from a time when the door is opened to a time when the door is closed.

7. The controlling method of the sale system according to claim 1, wherein in the step of determining whether the product is taken,
whether the product is disappeared from the image is determined; or
whether a radio frequency identification (RFID) of the product is out of a sensing range is determined; or
whether a weight of a pallet carrying the product is changed is determined; or
whether a magnetic button attached to the product is separated is determined.

8. A sale system, comprising:
a data acquisition unit, configured to obtain a consumer payment information and withdrawal rights;
a door;
a door control unit, configured to unlock the door when the consumer payment information and withdrawal rights is obtained;
a first image capturing unit, configured to capture an image of a product;
a determining unit, configured to determine whether the product has been taken according to the image or a sensing information, when the door is closed; and
a payment unit, configured to charge a payment based on the consumer payment information and withdrawal rights, when the product has been taken.

9. The sale system according to claim 8, further comprising a box, the box is a sample box or a product box, the door is disposed on the box, the product box is used for placing the product, and the sample box is used for placing a sample.

10. The sale system according to claim 8, further comprising:
a second image capturing unit, configured to capture a face image of a user;
wherein the data acquisition unit includes an external input device, a face recognizer or a card reader, the external input device is configured to provide at least one inputting field, and to receive the consumer payment information and withdrawal rights via the inputting field, the face recognizer is configured to obtain the consumer payment information and withdrawal rights according to the face image, the card reader is configured to read a card and obtain the consumer payment information and withdrawal rights according to the card.

11. The sale system according to claim 10, wherein the external input device is disposed on the door, and the door is light transmittable.

12. The sale system according to claim 8, wherein the first image capturing unit is disposed on the door, and the first image capturing unit is rotated with the door.

13. The sale system according to claim 8, wherein the image is captured from a time when the door is opened to a time when the door is closed.

14. The sale system according to claim 8, wherein
the determining unit determines whether the product is disappeared from the image; or
the determining unit determines whether a radio frequency identification (RFID) of the product is out of a sensing range; or
the determining unit determines whether a weight of a pallet carrying the product is changed; or
the determining unit determines whether a magnetic button attached to the product is separated.

15. A sale system, comprising:
a data acquisition unit, configured to obtain a seller payment information and withdrawal rights;
a door;
a door control unit, configured to unlock the door when the seller payment information and withdrawal rights is obtained;
a first image capturing unit, configured to capture an image of a product;
a determining unit, configured to determine whether the product has been placed according to the image or a sensing information, when the door is closed; and
an archiving unit, configured to create a sales data according to the seller payment information and withdrawal rights, when the product has been placed.

16. The sale system according to claim 15, further comprising:
a second image capturing unit, configured to captured a face image of a user;
wherein the data acquisition unit includes an external input device, a face recognizer or a card reader, the external input device is configured to provide at least one inputting field, and to receive the seller payment information and withdrawal rights via the inputting field, the face recognizer is configured to obtain the seller payment information and withdrawal rights according to the face image, the card reader is configured to read a card and to obtain the seller payment information and withdrawal rights according to the card.

17. The sale system according to claim 15, wherein the external input device is disposed on the door, and the door is light transmittable.

18. The sale system according to claim 15, wherein the first image capturing unit is disposed on the door, and the first image capturing unit is rotated with the door.

19. The sale system according to claim 15, wherein the image is captured from a time when the door is opened to a time when the door is closed.

20. The sale system according to claim 15, wherein
the determining unit determines whether the product is appeared in the image; or
the determining unit determines whether a radio frequency identification (RFID) of the product is entered a sensing range;
the determining unit determines whether a weight of a pallet carrying the product is changed.
